(19) United States
(12) Patent Application Publication
(10) Pub. No.: US 2003/0015915 A1
(43) Pub. Date: Jan. 23, 2003

(54) Brake unit

(76) Inventors: Manfred Ruffer, Sulzbach (DE); Ulrich Neumann, Rossdorf (DE); Andreas Klein, Bad Homburg (DE); Johann Jungbecker, Badenheim (DE); Christian Albrich von Albrichsfeld, Darmstadt (DE); Norbert Ruppert, Dieburg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/182,848

(22) PCT Filed: Jan. 25, 2001
(86) PCT No.: PCT/EP01/00832

(30) Foreign Application Priority Data
Feb. 2, 2000 (DE) 10004518.9

(51) Int. Cl. B60T 8/40

(52) U.S. Cl. 303/116.4

(57) ABSTRACT

In an electronically controllable brake unit for automotive vehicles, including a pressure generating device for generating a hydraulic pressure and a drive unit, a particularly low-noise design that is optimized with respect to the reduction of radial forces on the motor bearing is achieved because the pressure generating device is an internal gear pump (4). Preferably, the internal gear pump (4) is designed as a cartridge and attached in the valve block (1) by way of a clinch-type connection.

### TECHNICAL FIELD

The present invention generally relates to vehicle brakes and more particularly relates to a brake unit for automotive vehicles with a pressure generating device for generating a hydraulic pressure and with a drive unit for the pressure generating device.

### BACKGROUND OF THE INVENTION

Electronically controllable brake systems for automotive vehicles including a pressure generating device designed as a piston pump for generating a hydraulic pressure and a driving unit for this purpose are known from prior art. A pump configured as a stepped piston pump is disclosed in German publication DE 43 16 986 A1.

Piston pumps in this application suffer from the disadvantage of a function-induced pressure pulsation that depends particularly on the number of pistons used. A certain noise level is thereby produced that can be unacceptable in the passenger compartment. This circumstance is likely to impair the comfort, in particular, when a piston pump is employed in EHB systems (Electro-Hydraulic Brake systems).

Further, so-called internal gear pumps are known from the art. European patent application EP-A-0 848 165 A2 shall be referred to as an example. This patent application discloses an internal gear machine without a filler piece, comprised of a housing, a bearing ring that is received in a bore of the housing so as to be transversely movable, yet unrotatable, relative to its axis, a toothed ring gear circumferentially supported in the bearing ring, and a pinion pivoted in the housing.

### BRIEF SUMMARY OF THE INVENTION

An object of the present invention is to avoid the shortcomings of the state of the art, and to improve upon an electronically controlled brake system of the above-mentioned type so that only a reduced noise level occurs during the pressure generating phases, in particular in EHB systems.

The object of the present invention is achieved in a brake system wherein the internal gear pump is an independent construction unit.

An advantage of the present invention is that only torques are transmitted in an internal gear pump, (i.e., that lower radial forces act on the motor bearing than in a radial piston pump). Besides the low-pulsation operation, this permits a less costly design of the motor bearing in particular.

According to another advantage of the present invention the assembly of the brake unit is simplified and external pre-testing of the pump is possible.

Preferably, the internal gear pump is configured as a cartridge. A simple integration of the pump into a HCU (Hydraulic Control Unit) of an electronically controlled brake system is thereby achieved.

To reach an especially stable connection that prevents manipulations to the brake system in particular, the internal gear pump is attached in a valve block of a hydraulic control unit by at least one clinch-type or calk-type connection.

Preferably, a pressure-side port of the pressure generating device is connected to a valve assembly configured as a cartridge, wherein the valve assembly includes a non-return valve and a pressure-limiting valve. This also achieves the ability to pre-test the valve assembly externally as well as a simplified assembly.

To obtain a particularly stable connection that especially prevents manipulations at the brake system, the valve assembly is attached in a valve block of a hydraulic control unit by way of a clinch-type or calk-type engagement.

Advantageously, a shaft of the drive unit is guided in a bearing, the said bearing being arranged in a valve block of a hydraulic control unit. This eliminates the need for a massive motor flange to take up the bearing forces because the latter forces are received in the valve block. The bearing plate can be configured as a simple molded plastic part in this case.

A particularly compact structural shape of the pump is achieved when the pump includes a housing part and a cover part, with the housing part and the cover part being interconnected by means of lanced indentations. Contamination of the system by chips is also prevented due to the connection by means of lanced indentations.

Preferably, a low-pressure chamber is designed in the pump aspiration area of the pressure generating device. Especially in an OHB application, the demands placed on the shaft seals of the motor shaft, i.e., the resistance to high pressure of a shaft seal, may be reduced this way. The low-pressure chamber is favorably connected to a low-pressure accumulator or a like element.

To avoid excessive clutch wear, a clutch device for coupling the drive unit and the pressure generating device is arranged in the low-pressure chamber.

### BRIEF DESCRIPTION OF THE DRAWINGS

FIG. 1 is a schematic cross-sectional view (partly broken away and exploded) of a motor-and-pump assembly according to a first embodiment of the present invention.

FIG. 2a is a schematic cross-sectional view of the internal gear pump according to FIG. 1.

FIG. 2b is a schematic view of a cross-section of the ring gear and pinion taken along line IIb-IIb of FIG. 2a.

FIG. 3 is a schematic cross-sectional view of the valve cartridge according to FIG. 1.

FIG. 4 is a schematic cross-sectional view (partly broken away) of the motor-and-pump assembly according to FIG. 1 in the assembled condition.

FIG. 5 is a schematic block diagram of the motor-and-pump assembly according to the first embodiment of the present invention as shown in FIGS. 1 to 4.

FIG. 6 is a schematic partial cross-sectional view of a motor-and-pump assembly according to a second embodiment of the present invention.

FIG. 7 is a schematic partial cross-sectional view of a motor-and-pump assembly according to a third embodiment of the present invention.

FIG. 8 is a schematic partial cross-sectional view of a motor-and-pump assembly according to a fourth embodiment of the present invention.

FIG. 9 is a schematic partial cross-sectional view of a motor-and-pump assembly according to a fifth embodiment of the present invention.

FIG. 10 is a schematic partial cross-sectional view of a motor-and-pump assembly according to a sixth embodiment of the present invention.

### DETAILED DESCRIPTION OF THE PREFERRED EMBODIMENTS

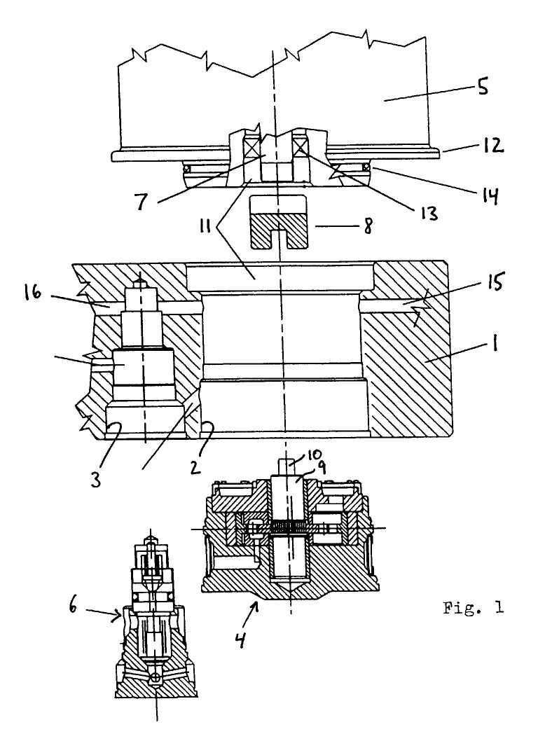

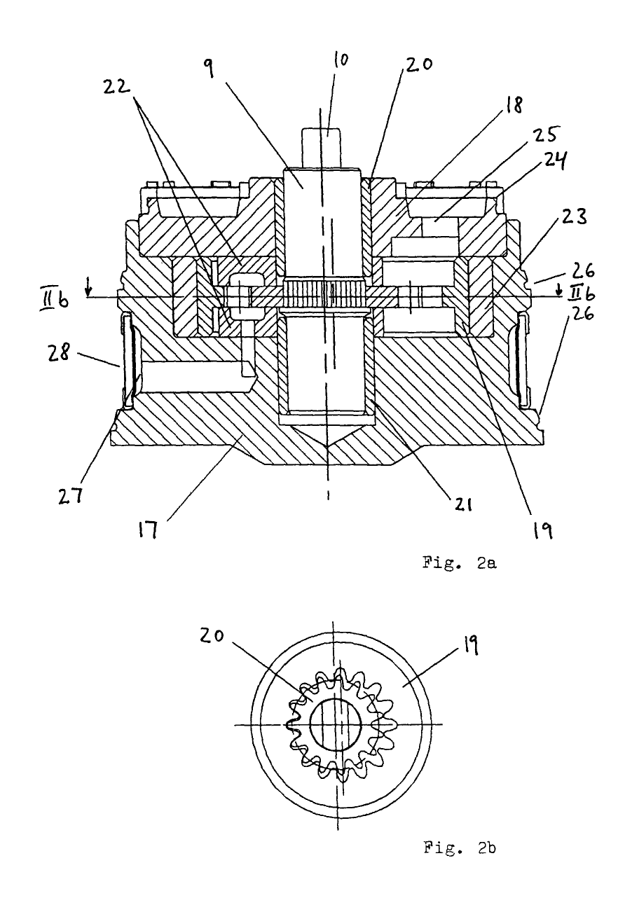

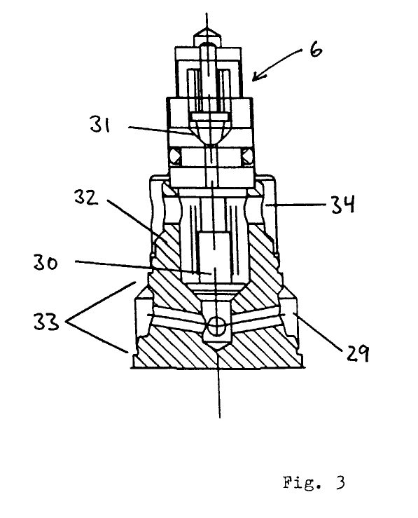

A first embodiment of the present invention will be described in the following in connection with FIGS. 1 to 5. The motor-and-pump assembly of the present invention is schematically shown in FIG. 1 in an exploded, partly cross-sectional view. Reference numeral 1 designates a valve block or HCU block of a hydraulic control unit of an electronically controlled brake system. Two essentially parallel arranged recesses 2 and 3 are provided in valve block 1. Recess 2 accommodates an internal gear pump 4 which is explained in detail with respect to its design in connection with FIGS. 2a and 2b. While the internal gear pump 4 is mounted in a bottom part of the recess 2 and is generally flush with an opening of recess 2. Motor 5 is fastened in the opposite top part of the recess 2. Recess 3 is used to accommodate a valve assembly 6 configured as a cartridge. Valve assembly 6 will be explained in detail in the following by making reference to FIG. 3. The motor shaft 7 is coupled to a pin 10 that is designed at the top end of the pinion shaft 9 by way of a clutch 8. Clutch 8 eliminates the transfer forces between shaft 7 and pin 10. The motor shaft 7 operates in wet practice in suction chamber 11 and is sealed by a sleeve 13 at a bearing plate 12 of motor 5. An O-ring seal 14 integrated in the bearing plate 12 is provided to seal the suction chamber 11 towards the outside. Further, valve block 1 includes a supply portion 15 of the supply reservoir. On the opposite side, a return port 16 for control valves is designed in valve block 1. Ports 15, 16 are connected to the suction chamber 11.

FIG. 2a schematically shows a cross-sectional view of the internal gear pump 4 employed according to the present-invention. The internal gear pump 4 includes a pump housing 17, a pump cover 18, and a ring gear 19. A one-part or multi-part pinion 20 (see FIG. 2b) moves rotatorily in sliding sleeves 21 and radial discs 22 in the ring gear 19. The ring gear 19 is radially supported in the pump housing 17 by a slide ring 23. The pump cover 18 is furnished with an integrated suction filter 24 and, thus, forms a suction port 25 of the internal gear pump 4. After pre-assembly of the inner parts, the pump cover 18 is calked with the pump housing 17. Generally, the pump housing 17 of the internal gear pump 4 has a one-part design and clinched contours 26 at its periphery. Also, the pump housing 17 receives an annular pressure port 27 and a pressure filter 28. With respect to further details of the design and operation of the internal gear pump 4 used according to the present invention, reference again is expressly made to the publication of European patent application EP-A-0 848 165 A2 mentioned in the introductory part of the description.

FIG. 2b shows a schematic top view of a cross-section taken along line IIb-IIb in FIG. 2a. In connection with FIG. 3, the design of the valve assembly 6 configured as a cartridge will be explained in the following in further details. A pressure port 29 of the valve cartridge 6 is connected to the annular pressure port 27 of the internal gear pump 4 in the installation position as defined. The valve cartridge 6 includes a return valve 30 and a pressure-limiting valve 31. Housing 32 of the valve cartridge 6 is of one-part design. At the outside periphery of the housing 32, exactly as at the outside periphery of the pump housing 17, clinched contours 33 are provided with a view to fixing the valve cartridge in the valve block 1. An annular channel 34 of the non-return valve 30 supplies the control valves or the accumulator with the necessary supply pressure. In the event that an allowable system pressure is exceeded, the pressure-limiting valve 31 will open and connect the annular channel 34 to the suction port chamber 11 of the internal gear pump 4. Please note that the valve cartridge 6 is also an independent construction unit that can be pre-tested from outside in particular.

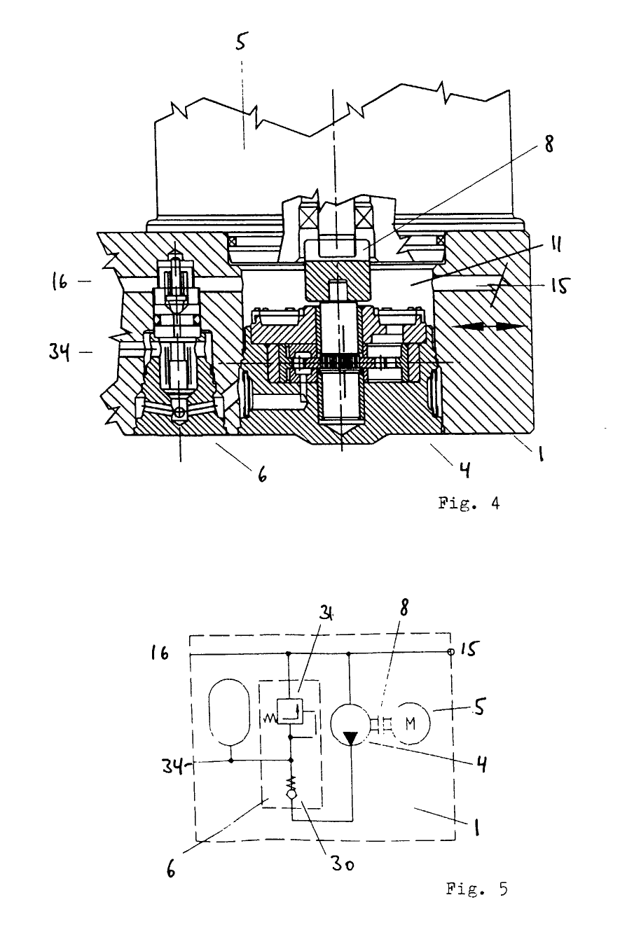

For further explanation of the present invention, the motor-and-pump assembly is shown in the condition as mounted into the valve block 1 in FIG. 4. FIG. 5 shows a schematic hydraulic wiring diagram of the motor-and-pump assembly as well as of the valve assembly 6.

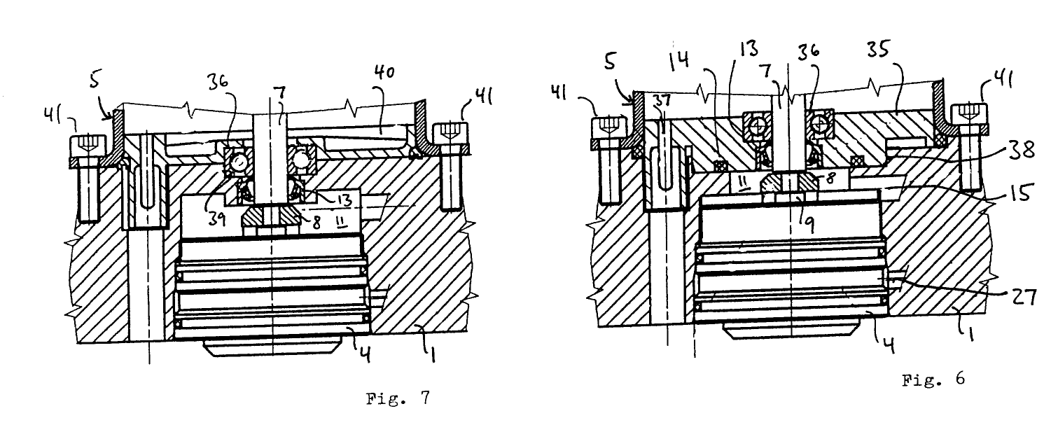

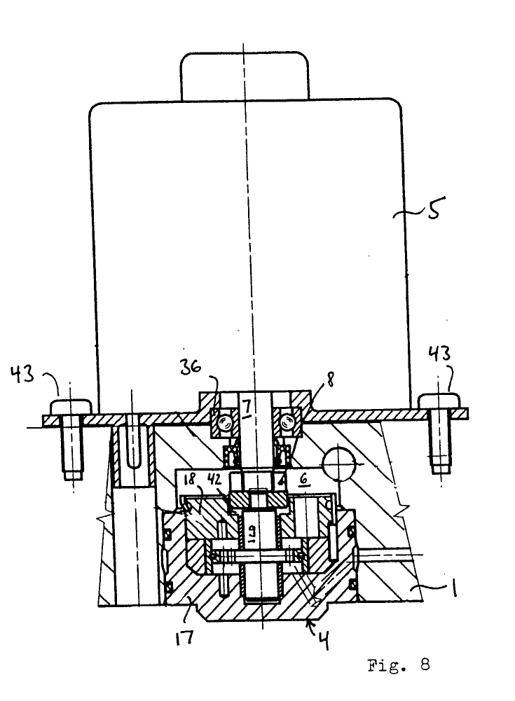

A second embodiment of the present invention is described in the following in connection with the schematic cross-sectional view of FIG. 6. In contrast to the first embodiment described in connection with FIGS. 1 to 5, the motor 5 includes a massive motor flange 35 that centers a bearing 36 and a sleeve or shaft sealing ring 13. In addition, the motor forces introduced through the motor shaft 7 are received in the motor flange 35. Together with the shaft sealing ring 13, the sealing ring 14 ensures the sealing of the suction chamber 11 wherein the clutch 8 during operation transmits the motor torque to the pump 4 which is favorably designed as an internal gear pump. The motor flange 35 is connected to the valve block 1 by way of a contacting means 37. On the side close to the valve block 1, the motor flange 35 has a centering collar 38 which ensures the alignment of the motor shaft 4 and the pump shaft 9.

FIG. 7 shows an embodiment according to a third embodiment of the present invention which is improved compared to the second embodiment illustrated in FIG. 6. In contrast to the second embodiment illustrated in FIG. 6, the centering collar 38 (see FIG. 6) is omitted in the third embodiment of the present invention. At the point of passage of the motor shaft 7, valve block 1 includes a bearing centering bore 39 which, on the one hand, accommodates the rotor force of the motor 5, and centers the motor shaft 4, on the other hand. Thus, sealing of the suction chamber 11 is ensured due to the side of the valve block 1 facing the motor 5 being basically closed (apart from the bearing centering bore 39), along with the shaft sealing ring 13. In contrast to the second embodiment illustrated in FIG. 6, there is also no need for a massive motor flange 35 (as in FIG. 6). A simple bearing plate 40 which, due to being exposed to low loads, is favorably designed as a molded plastic part is absolutely sufficient in operation. The housing of the motor 5 is attached to the valve block 1 by way of a screw coupling 41. The shorter overall length of the internal gear pump 4 compared to the second embodiment of the present invention shown in FIG. 6 is achieved because the two pump housing halves 17, 18 are interconnected by lanced indentations. This way, a coupling without a clearance is obtained which, beside the advantage of saving space due to the short construction, especially compared to screw couplings, also prevents contamination of the system by chips.

The embodiment of the present invention illustrated in FIG. 8 shows a connection between motor 5 and pump 6 by means of the valve block 1 which is optimized in terms of components. In particular, it becomes apparent from the illustration of FIG. 8 that at the pump cover 18, i.e., the top housing half of the internal gear pump 4, there is designed a stepped bore or step 42 which especially adopts the function of centering the clutch 8 for the assembly of the electric motor 5. A filter (not shown) is optionally integrated in the suction chamber 6. A partial press fit between the pump housing 17 and the valve block 1 ensures the support of torques and prevents the pump 4 from detaching from the valve block 1. Due to the optimized connection, the screw coupling 41 (see FIGS. 6 and 7) can be replaced by a rivet connection indicated by reference numeral 43.

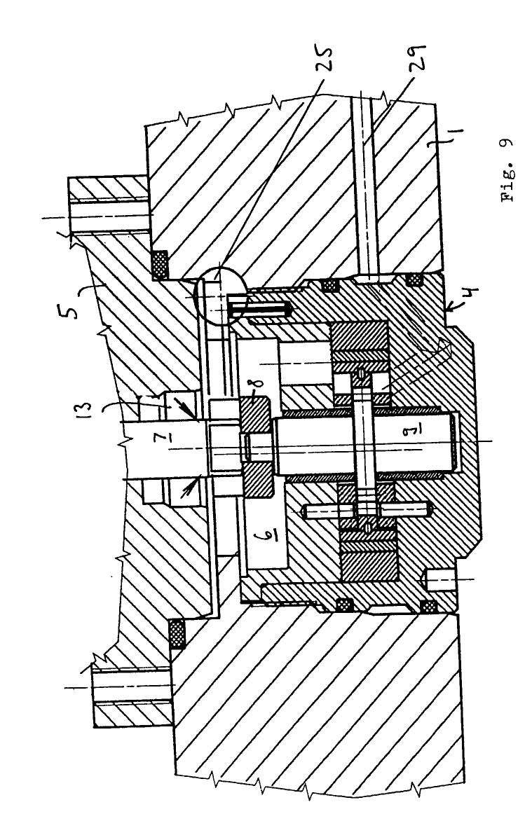

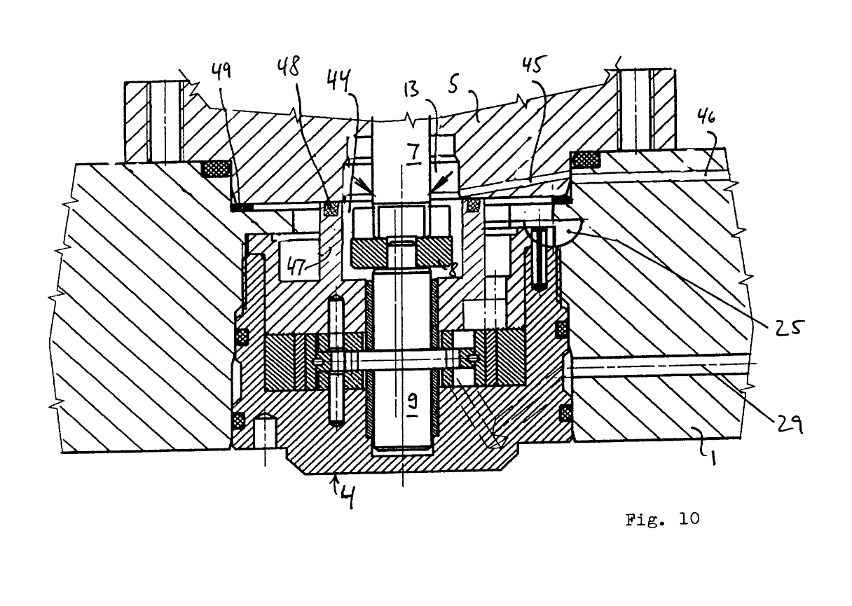

Due to the operation of the internal gear pump 4 which additionally ensures a pressure increase, a fourth embodiment of the present invention is illustrated schematically in a cross-sectional view in FIG. 9. Pressure fluid propagates into an accumulator (not shown) through the suction bore 25, and through the pressure bore 29 also in the embodiment of FIG. 9. The design of the fourth embodiment of the present invention illustrated in FIG. 9 is advantageous especially in connection with an EHB application (electro-hydraulic brake). Reference is made especially to the description and the drawing of the first embodiment for further details with respect to the embodiment illustrated in FIG. 9. It will be appreciated that the sealing sleeve 13 in the preferred EHB case is loaded with low suction pressures only.

In contrast thereto, a sixth embodiment of the present invention is schematically shown in a cross-sectional view in FIG. 10, which is preferred especially for an OHB application or for an OHB circuit (Optimized Hydraulic Brake). The design of the pumps in FIGS. 9 and 10 is generally similar, however, the pump preferred for the OHB application has larger dimensions. In contrast to the case of the EHB application, the pressures introduced through the suction port 25 can be considerably higher than in the EHB case and e.g. amount to 200 bar approximately. Therefore, a low-pressure chamber 44 is provided in the pump aspiration area beside the sealing sleeve 13 in the embodiment of FIG. 10, which is in contrast to the embodiment illustrated in FIG. 9. The low-pressure chamber is connected to a (non-illustrated) low-pressure accumulator or reservoir by way of channels 45 (in the motor housing 5) and 46 (in the valve block 1). The low-pressure chamber 44 is provided by a cylindrically shaped sleeve portion 47 that is sealed by an inward sealing ring 48 and an outward sealing ring 49. The inward sealing ring 48 is designed in a corresponding recess on the side of the sleeve portion 47 facing the motor 5. The outward sealing ring 49 is arranged in a stepped bore between motor 5 and valve block 1. The pressurization of the sealing sleeve 13, that is especially high in an OHB application, is minimized in the embodiment illustrated in FIG. 10. The problem of a rotating radial shaft seal that is subjected to high pressure is otherwise difficult to solve. Leakage of the pump may thus flow off.

It shall be noted that valve assembly 6 was not shown or described in connection with the second to sixth embodiments of the present invention. Of course, a corresponding valve assembly may be provided optionally, and a design as a valve cartridge is especially preferred.

List of Reference Numerals:

| | |
|---|---|
| 1 | valve block or HCU block |
| 2 | recess |
| 3 | recess |
| 4 | (internal gear) pump |
| 5 | (electric) motor |
| 6 | valve assembly or valve cartridge |
| 7 | motor shaft |
| 8 | clutch |
| 9 | pinion |
| 10 | pin |
| 11 | suction chamber |
| 12 | bearing plate |
| 13 | sleeve or shaft sealing ring |
| 14 | O-ring seal or sealing ring |
| 15 | supply port |
| 16 | return port |
| 17 | pump housing |
| 18 | pump cover |
| 19 | ring gear |
| 20 | pinion |
| 21 | sliding sleeve |
| 22 | radial disc |
| 23 | slide ring |
| 24 | suction filter |
| 25 | suction port |
| 26 | clinched contours |
| 27 | pressure port |
| 28 | pressure filter |
| 29 | pressure port |
| 30 | non-return valve |
| 31 | pressure-limiting valve |
| 32 | housing |
| 33 | clinched contour |
| 34 | annular channel |
| 35 | motor flange |
| 36 | bearing |
| 37 | contacting means |
| 38 | centering collar |
| 39 | bearing centering bore |
| 40 | bearing plate |
| 41 | screw coupling |
| 42 | stepped bore |
| 43 | rivet connection |
| 44 | low-pressure chamber |
| 45 | channel |
| 46 | channel |
| 47 | sleeve portion |
| 48 | inward sealing ring |
| 49 | outward sealing ring |

1. Electronically controllable brake unit for automotive vehicles with a pressure generating device for generating a hydraulic pressure and a drive unit for the device,
characterized in that the pressure generating device is an internal gear pump (4).

2. Brake unit as claimed in claim 1,
characterized in that the internal gear pump (4) is an independent construction unit.

3. Brake unit as claimed in claim 2,
characterized in that the internal gear pump (4) is configured as a cartridge.

4. Brake unit as claimed in any one of the preceding claims 1 to 3,
characterized in that the internal gear pump (4) is attached in a valve block (1) of a hydraulic control unit by at least one clinch-type or calk-type connection (26).

5. Brake unit, especially as claimed in any one of claims 1 to 4,
characterized in that a pressure-side port of the pressure generating device is connected to a valve assembly (6) configured as a cartridge, the said valve assembly including a non-return valve (30) and a pressure-limiting valve (31).

6. Brake unit as claimed in claim 5,
characterized in that the valve assembly (6) is attached in a valve block (1) of a hydraulic control unit by way of a clinch-type or calk-type connection (33).

7. Brake unit, especially as claimed in any one of claims 1 to 6,
characterized in that a shaft (7) of the drive unit is guided in a bearing (36), the said bearing (36) being arranged in a valve block (1) of a hydraulic control unit.

8. Brake unit, especially as claimed in any one of claims 1 to 7,
characterized in that the pressure generating device is a pump including a housing part (17) and a cover part (18), with the housing part (17) and the cover part (18) being interconnected by means of lanced indentations.

9. Brake unit, especially as claimed in any one of claims 1 to 8,
characterized in that a low-pressure chamber (44) is designed in the pump aspiration area of the pressure generating device.

10. Brake unit as claimed in claim 9,
characterized in that the low-pressure chamber (44) is connected to a low-pressure accumulator or a like element.

11. Brake unit as claimed in claim 9 or 10,
characterized in that a clutch device (8) for coupling the drive unit and the pressure generating device is arranged in the low-pressure chamber (44).
